(19) United States
(12) Patent Application Publication
(10) Pub. No.: US 2025/0184392 A1
(43) Pub. Date: Jun. 5, 2025

(54) Systems and Methods for Implementing Autonomous Discovery of and Peer-to-Peer Connections Between Blockchain Nodes

(71) Applicant: Collaborative Digital Innovations LLC, Lake Mary, FL (US)

(72) Inventors: Taylor Cox, Bowmanville (CA); Chad Justice, Lake Mary, FL (US); Brenton Thai, Orlando, FL (US); Timothy Benedict, Greenwood, IN (US)

(21) Appl. No.: 18/829,225

(22) Filed: Sep. 9, 2024

Related U.S. Application Data
(60) Provisional application No. 63/537,451, filed on Sep. 8, 2023.

(51) Int. Cl. H04L 67/1061

(52) U.S. Cl. CPC H04L 67/1068

(57) ABSTRACT

A novel computing appliance uses network-bound listening events to enable automated peer discovery to establish secure connection tunnels to a peer-to-peer (P2P) blockchain network. The appliance employs a zero-trust framework, ensuring secure and reliable communication between peers which creates a native, zero-trust P2P network between all nodes. By automating P2P networking for blockchain nodes through the preconfigured appliance, operators are able to connect and participate in specific blockchain environments, from an infrastructure level, with little to no experience or technological knowledge, improving the scalability and decentralization of blockchain networks.

This application claims the benefit of U.S. Provisional Application Ser. No. 63/537,451, filed Sep. 8, 2023, the entire specification of which is incorporated herein by reference.

### TECHNICAL FIELD

The present invention relates generally to electronic systems and methods that automate the discovery of and formation of blockchain node connections.

### BACKGROUND ART

A variety of blockchain architectures have been developed. Generally, blockchain systems operate with a large number of nodes to support transaction processing and maintain the blockchain ledger. Conventional processes for operating a node involve managing the configuration, maintenance and well-being of cloud-based virtual machines, hardware systems or other such computing devices, requiring the operator to have significant IT skills or knowledge.

The inventors have determined that there is a need for improved, automated systems and methods for discovering nodes, establishing peer-to-peer connections, and operating a blockchain network to perform various functions.

### BRIEF SUMMARY OF THE INVENTION

Example embodiments described herein disclose a novel computing appliance that enhances the functionality and security of blockchain networks. In preferred embodiments, the appliance automates the process of peer discovery and establishes a secure, bidirectional network tunnel to a P2P blockchain network using a zero-trust framework.

In an example embodiment, the computing appliance acts as a gateway between individual participants (peers) and the blockchain network. By leveraging automation techniques, the appliance is preconfigured to be detected by the network peer scanning which automatically connects verified hardware and exposes it as a new peer to other nodes within the network, expanding the blockchain protocol. This automated peer discovery process eliminates the need for manual intervention, reducing administrative overhead and improving network scalability.

The computing appliance provides, in an example embodiment, novel zero-trust secure connection network tunnels that establish a secure communication channel between peers, ensuring data integrity and confidentiality. In example embodiments, the computing appliance employs robust encryption algorithms and authentication mechanisms to facilitate secure data transmission within the P2P network. This approach mitigates potential security vulnerabilities and reduces the risk of unauthorized access or data tampering.

The combination of automated peer discovery and zero-trust secure connection tunnels presents a novel advancement for blockchain technology. This approach improves the efficiency and reliability of P2P blockchain networks by simplifying the process of finding compatible peers and establishing secure communication channels. Additionally, it enhances the security of blockchain transactions, thereby bolstering trust among network participants and strengthening the overall integrity of the system.

### BRIEF DESCRIPTION OF THE DRAWINGS

The accompanying drawings, which are incorporated herein and form a part of the specification, illustrate various exemplary embodiments of the present invention and, together with the description, further explain various principles and to enable a person skilled in the pertinent art to make and use the invention.

FIG. 1 shows an example reference architecture that illustrates optional configurations of appliances for use with primary or sub-level blockchain networks for the purpose of validation.

FIG. 2 is a flow chart showing an example process for user acquisition of an appliance and beginning validation operations on a blockchain network.

FIG. 3 is a flow chart showing an example process for validating a user's credentials via a third party Know Your Customer services provider, such as Onfido.

FIG. 4 is a flow chart showing an alternative embodiment of the process for allowing user access to the blockchain network.

FIG. 5 is a block schematic diagram showing peer-to-peer (P2P) connections in a blockchain network.

FIG. 6 is a block schematic diagram of an example embodiment of the appliance connected to a Cloudflare WARP client.

FIG. 7 illustrates base-level and sub-level configurations that can be dynamically adjusted within an example embodiment of network software,

### BEST MODE FOR CARRYING OUT THE INVENTION

The present invention will be described in terms of one or more examples, with reference to the accompanying drawings.

The present invention will also be explained in terms of exemplary embodiments. This specification discloses one or more embodiments that incorporate the features of this invention. The disclosure herein will provide examples of embodiments, including examples from which those skilled in the art will appreciate various novel approaches and features developed by the inventors. The novel approaches and features disclosed herein may be used individually, or in combination with each other as desired.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases do not necessarily refer to the same embodiment. Further, when a feature, structure, or characteristic is described in connection with an embodiment, persons skilled in the art may implement such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors, typically distributed in a network. A machine-readable medium may include any mechanism for storing or transmitting information in a form readable by a machine (e.g., a computing device). For example, a machine-readable medium may include read only memory (ROM); random access memory (RAM); hardware memory in handheld computers, tablets, smart phones, and other portable devices; magnetic disk storage media; optical storage media; flash memory devices; electrical, optical, acoustical, or other forms of propagated signals (e.g. carrier waves, infrared signals, digital signals, analog signals, etc.), Internet cloud storage, and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

In example embodiments herein, a preconfigured blockchain node computing appliance is provided to enable improved discovery of peer nodes and establishment of robust network connections to support blockchain functions.

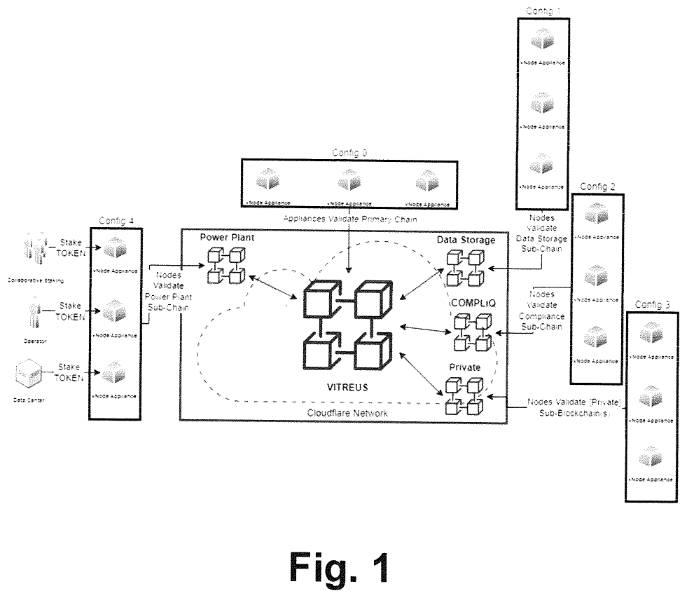

FIG. 1 shows an example reference architecture that illustrates optional configurations of appliances for use with primary or sub-level blockchain networks for the purpose of validation. As indicated in FIG. 1, single, group or data center users can participate in validation through different variations of an appliance provided that (in a preferred embodiment) they include a “stake” of a utility token used in operating the blockchain network. The appliances, while prefabricated, can take different forms and employ a specific process between the pre-exposed RPC endpoints and the Zero Trust framework around their node software within the appliance, which may be deployed in a small device or in a data center. The example blockchain in question has uses for the appliance operating process beyond just network validation. Appliances can be different types of hardware machine such as ones dedicated for providing storage space or handling artificial intelligence inference and training workloads.

An example blockchain network operating with an example token may deploy various appliance types for its Sub-Chain systems. Examples of appliance types include, but are not limited to:
1. Validate: Appliance designed to perform consensus validation for the blockchain. This is primarily shown and used as an example here.
2. Network: Appliance designed to perform AI interference and training workloads for users of the network.
3. Storage: Appliance designed to provide storage space so that the network has ample access to decentralized storage

Hardware requirements for different types of appliances will change depending on the type, but in example embodiments the process of being preconfigured and able to connect to the P2P network with pre-exposed RPC endpoints remains.

An appliance, in this example embodiment, is any device that is running pre-configured hardware designed to utilize the automation of: network connection, discovery of peers and has RPC endpoints pre-exposed for rapid utilization by the network.

To connect a node to the network, there are preferably a minimum quantity of tokens connected to the node which represent a “stake” in the network. In a blockchain network operating on proof of stake, all entities that will act as a node are preferably required to have an associated stake.

Appliances are preferably wrapped in a special client, for example the Cloudflare WARP Client, which creates a secure tunnel across the internet, in this example via the Cloudflare Network, to connect one node to another to form a secured, permissioned, P2P network environment.

The example blockchain network has various sub-blockchains that connect to the primary network, which typically require different pre-configurations for automated discovery and exposure to peers. All of these configurations in this example embodiment require a “stake.”

Each configuration is set to be a part of the blockchain network as a specific network and can dynamically be rerouted for validation on any change as per load balancing and smart routing technology.

In an example embodiment, the computing appliance serves as a computing machine, capable of executing various tasks and running software applications. The appliance is preconfigured during manufacturing with the required hardened Operating System (OS), Node Software, and hardware drivers, operating within a pre-approved Zero Trust Client that assists with the triggering of RPC endpoint exposure upon bootup of the appliance. The computing device is preferably optimized to run blockchain-related tasks and securely connect to a blockchain network based on its configuration. Furthermore, the permissions a device has varies by the network-based reputation and the cryptocurrency stake of the user that owns/operates the device. The appliance disclosed herein is an improvement on existing methods for self-hosted node operation within the realm of blockchain technology. Conventionally, node operators manage the configuration, maintenance and well-being of cloud-based virtual machines, hardware systems or other such computing devices, requiring significant information technology skills. The appliance disclosed herein, in embodiments, reduces this complexity by streamlining hardware setup into three steps.

The first step is to connect the appliance to power, such as by plugging an onboard power supply into a standard outlet to provide the power needed to operate the appliance.

Next, the appliance is connected to the internet. In an embodiment, The appliance acts as a relay, facilitating a connection between the blockchain network and the user's Wi-Fi network, ensuring seamless communication. In addition to Wi-Fi connectivity, the appliance also preferably supports Ethernet connectivity, providing flexibility in network connection options and a more consistently reliable connection.

Finally, the appliance is connected to a Cryptographic Wallet, using instructions provided by the manufacturer. For example, a QR code can be provided in the appliance packaging as a link to a webpage that provides detailed instructions. The appliance is preferably designed for easy installation and setup, allowing users to quickly connect and activate the device without complex configurations. In an example embodiment, setup is accomplished with three simple steps.

The first step in the example setup is auto-execution and connection to the network based on the appliance's configuration. After connection to a cryptographic wallet, the appliance automatically executes pre-configured settings and connects to the blockchain network, eliminating the need for manual intervention during setup. Prior to connection to the network, firmware, software and driver updates that have been approved for deployment will be pushed to the hardware appliance. The appliance will begin its connection to network peers and the user will begin being rewarded for their participation. For example, operator reputation and associated rewards may be initiated as soon as the appliance is connected to the network.

The second setup step is to initiate operation of the node software. The appliance preferably incorporates specialized node software that enables it to participate in the blockchain network as a node, contributing to the network's consensus and validation processes. The Node Software features a dynamic runtime that enables permissioned developers to “call home,” deploying exclusive & approved code to dynamically update the appliance with the latest version of Node Software. In this example, the Node Software is built on a WebAssembly runtime environment, which allows for the execution of WASM modules. This provides a modular architecture, where the Node Software is designed with different functionalities and components are encapsulated within separate WASM modules. The Node Software also preferably implements version control and dependency management mechanisms to track the different versions of WASM modules and their interdependencies. To update a specific WASM module, in an example embodiment, the Node Software utilizes a hot swapping mechanism. This allows the replacement of an existing module with an updated version without stopping the entire system. In addition, this feature allows each WASM module to operate within an isolated and sandboxed environment, ensuring that the update process does not affect the overall stability and security of the system. The Node Software preferably leverages the Just-In-Time (JIT) compilation capabilities of the WebAssembly runtime to dynamically compile and optimize updated WASM modules.

The third step is automated peer discovery. In the example embodiment, each appliance is accepted to the network and then automatically seeks to find peers to perpetuate the peer-to-peer blockchain network. With peers distributed geographically, a peer may become a bridge between many other peers or may only connect to a few others.

The software update process for the appliance is preferably atomic, meaning that either the entire update succeeds, or it is rolled back to the previous working state. This ensures that inconsistent or partial updates do not impact the system's stability. Thus, appliances preferably utilize an immutable operating system that is designed to have a functional partition and a passive partition that disallows updates that cannot be completed in full, triggering a roll-back therein.

In an embodiment, the appliance described herein is deployed in a rack-mounted hardware configuration, and each appliance may have the capacity to simultaneously operate as a plurality of nodes for businesses that want to utilize the blockchain network within their own data center. In this embodiment, a preconfigured hardware device encompasses the minimum technical specifications required for the validation of the blockchain in the form of two or more virtualized nodes within the hardware. Each virtualized node is preferably wrapped within the Zero Trust Framework and pre-configured generally in the same manner as single node devices.

The appliance can thus be deployed as a portable computing device and in other embodiments as an enterprise-scale device.

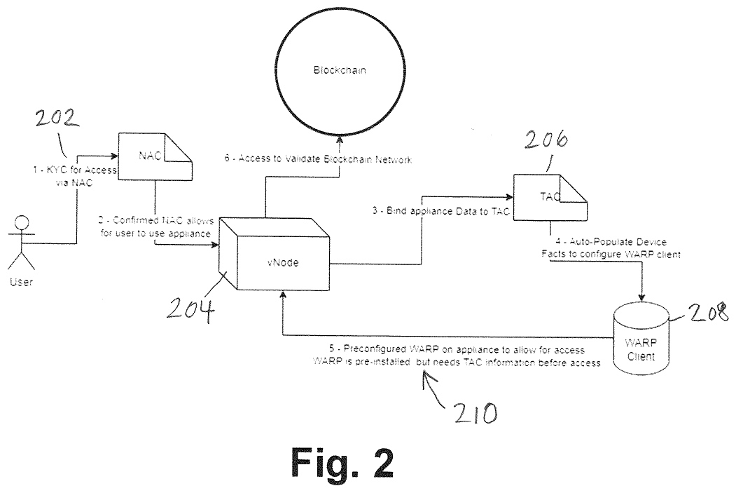

FIG. 2 is a flow chart of an example process for user acquisition of an appliance and beginning validation operations on a blockchain network. This process includes six total steps which begin with step 202, the verification of the user's identity via a NAC (Network Access Credential) process. In step 204, authentication of their identity and credentials allows the user to acquire an appliance. In step 206, the user then binds their appliance into a TAC (Terminal Access Credential) which aids in the final configuration of a Cloudflare WARP client that grants the appliance access to the network. In step 208, device facts are auto-populated to configure the WARP client, and in step 210 the preconfigured WARP client receives TAC information and obtains access.

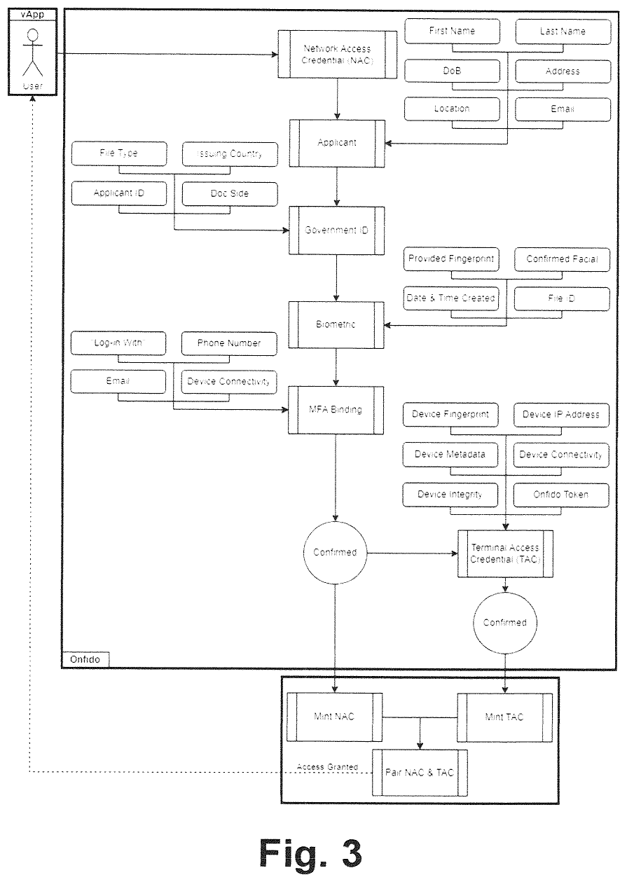

FIG. 3 is a flow chart of an example process for validating a user's credentials via a third party Know Your Customer services provider, for example, using services such as those provided by Onfido. Data input from the user is required to verify their identity along with example elements for confirming the device they are trying to obtain identification on. These processes, which have been referred to herein as NAC and TAC, effectively create a “bond” at the end of the process between the identified user and the user's device that is to access the network. The same verification process may be applied to users seeking to access blockchain functions generally and is not limited to users who will operate node appliances.

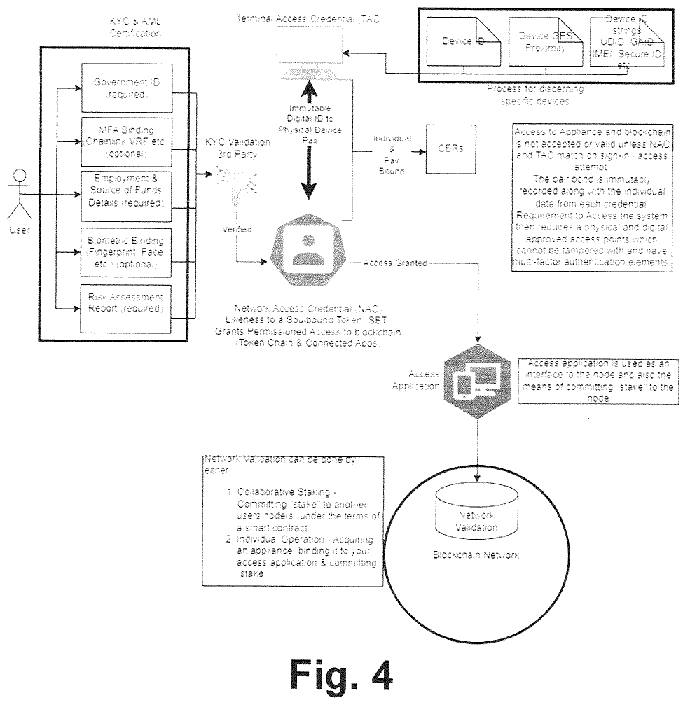

FIG. 4 is a flow chart of an alternative embodiment of a process for allowing user access to the blockchain network. In this embodiment, a 3rd party KYC provider is utilized to verify the user's personal identifiable information. Both the NAC and the TAC form a Controllable Electronic Record (CER) that is analogous to a Soulbound Token (SBT), which persists within the cryptographic wallet from whence it was created. In this example, only after both a NAC and a TAC have been created and bound together can the user access the network, which may or may not include blockchain validation.

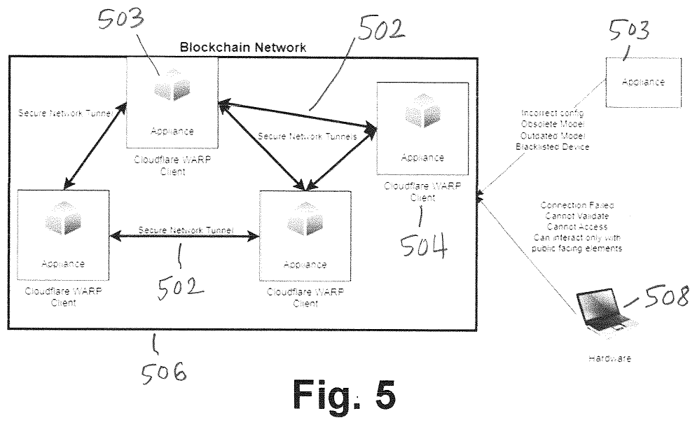

FIG. 5 is a block schematic diagram showing peer-to-peer (P2P) connections in a blockchain network. FIG. 5 shows Secure Network Tunnels 502 between each appliance 503, which is also wrapped in a Zero Trust Client, for example, the Cloudflare WARP Client 504. The appliances 503 preferably use zero-trust client 504 to create secure network tunnels 502 between appliances 503, forming a highly secure P2P network 506. FIG. 5 also depicts the appliances 503 described herein. Non-appliance hardware items are more difficult to connect to the network 506 for various reasons. Non-appliance Hardware 508 requires a configured Cloudflare WARP client, proper hardware specs and internet connectivity. Appliances 503 simplify the configuration process for users; non-appliance users will need to configure many elements and expose their own RPC endpoints. Even if RPC end points and node software are installed, the user of non-appliance hardware will still need to install the Cloudflare WARP client. These elements are only available to users that have gone through the Network Access Credential (NAC) process.

Appliances 503 are designed to be ready for connection. In the event a connection doesn't work, a user will need to adjust their Wi-Fi or Ethernet connection. Malicious Actors to the network are met with a declining reputation which could lead to being blacklisted, rendering the appliance unable to perform its tasks, cutting it off from the network. Unlike other Proof of Stake Networks, an example blockchain embodiment requires a KYC process prior to validation. This allows holding bad actors accountable in legal proceedings for any disruptive actions they take.

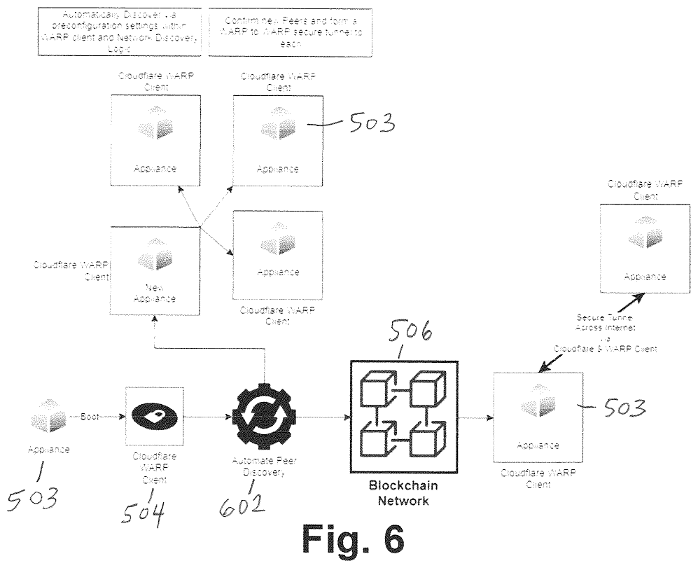

FIG. 6 shows a conceptual layout of how an example embodiment of the appliance 503 boots into the Cloudflare WARP client 504 which then aids in the automatic connection 602 to the pre-configured network and discovers peers. As indicated in FIG. 6, in this embodiment, as soon as one or more peers are connected to the freshly joined appliance, it will begin network validation as the RPC endpoints have been pre-exposed, allowing for it to be recruited for tasks as needed.

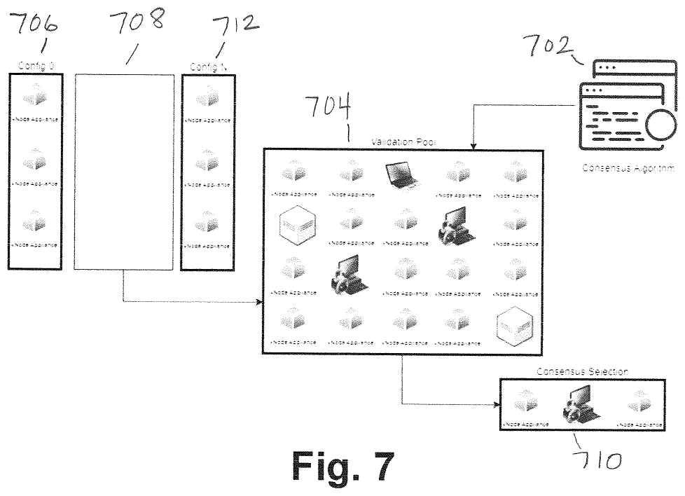

FIG. 7 shows base-level and sub-level configurations that can be dynamically adjusted within an example embodiment of network software, so that it is tasked where needed within the blockchain network, utilizing technologies such as load balancing and smart routing to ensure each network portion has the required tools to maintain peak performance. As shown in FIG. 7, in this example the blockchain networks consensus algorithm 702 selects X number of validation nodes (such as the novel appliances described herein) from the pool 704 of all approved validated hardware currently connected to the specific level of the network. In the example blockchain environment, there is a primary network 706 (config 0) and in this example, four sub-chains 708 (config 1-4), thus providing five different Validation Pools, one for each network portion to which the approved appliance hardware can be “moved between” to improve system performance based on traffic.

An exemplary Consensus Algorithm 702 selects, based on its requirements and functions, X quantity of appliances 710 from within the pool 704 for each transaction on the blockchain network and uses selected appliances 710 to participate within the network. Nodes increase in reputation for each successful and beneficial participation event in which they are involved.

Config 0 represents the participation in validation for the Primary Blockchain network. A routing target will be preset on all Validate-type appliances that will add it to the pool to be routed as needed by the network based on historical statistical requirements, smart routing & load balancing. Config N (712) represents the participation in validation for the sub-blockchain networks, using the same methods mentioned before.

As noted previously, the appliance preferably implements a zero-trust framework, providing secure network communication and data exchanges without relying on implicit trust between peers. The zero-trust framework is an approach to security that operates on the principle of “never trust, always verify.” It assumes that no user or device should be automatically trusted within a network, regardless of their location or previous access privileges. Instead, it requires continuous verification and authentication of every user and device attempting to access resources. While some conventional blockchains incorporate cryptographic verification and consensus mechanisms, layering a comprehensive zero trust framework on top of a blockchain network can provide additional security benefits by focusing on identity verification, access control, continuous monitoring, and other security measures.

As an example, the Cloudflare WARP Client may be installed on each node to communicate with other WARP Clients within the desired network. All devices equipped with the preconfigured WARP client settings can be detected and added to this network. In this example, the network is a P2P blockchain network that supports secure blockchain traffic, transactions and activities between the nodes and participants.

A Cloudflare, WARP to WARP, Peer-to-Peer (P2P) blockchain network as implemented in an example embodiment uses Cloudflare's WARP service to establish secure and efficient connections between network participants. Cloudflare WARP is a VPN-like service provided by Cloudflare that offers secure and private communication over the internet. It creates an encrypted tunnel between the user's device and Cloudflare's network, protecting data in transit. While the Cloudflare WARP service is one way to implement a secure tunnel, other mechanisms can be used to achieve similar results. As examples, other secure VPN replacements, bi-directional private communication, or general tunnel services can also be used. The OpenZiti service is another mechanism that can be used in this regard.

With RPC Endpoints already exposed, the blockchain Network will begin utilizing the new node when there is at least one connected peer.

Integration between Cloudflare WARP and the P2P blockchain network in this example embodiment involves establishing secure and reliable connections between network participants using Cloudflare's infrastructure. Each node establishes an encrypted connection with Cloudflare's network, ensuring data confidentiality and integrity.

Nodes within the P2P blockchain network preferably use Cloudflare WARP to discover and connect with other peers. Cloudflare's infrastructure aids in the discovery process by providing a reliable and scalable mechanism for peer identification. Each WARP client is configured to communicate directly with WARP clients within its group, allowing for the bi-directional communication of appliances to other appliances to maintain the coherent transference of ledge status commands. The bi-directional nature of WARP-to-WARP tunnels provides a private connection between each piece of node hardware and enables sharing of ledger status changes for uninhibited cross-internet traffic to update ledger states.

Cloudflare WARP manages the connections between blockchain network peers, ensuring efficient routing and optimized performance. It may employ load balancing techniques to distribute traffic among different nodes. Cloudflare's global network infrastructure optimizes the performance of the P2P blockchain network by reducing latency and improving data transfer speeds. It leverages caching, content delivery network (CDN) capabilities, and other optimization techniques.

Cloudflare WARP enhances the security and privacy of the P2P blockchain network by encrypting communications and protecting against network attacks. It adds an additional layer of protection to the decentralized network. Cloudflare's robust infrastructure and global presence contribute to the scalability and reliability of the P2P blockchain network. It helps ensure that the network can handle increased traffic and provides high availability. Cloudflare's load balancing and failover capabilities can be utilized to distribute incoming traffic among multiple blockchain network nodes, ensuring optimal resource utilization and fault tolerance.

In an embodiment, enhanced hardening techniques are used to effectively deploy an immutable operating system to appliances that operate with an Active/Passive partition. The active partition houses the currently used Operating System (OS) while the Passive portion awaits atomic updates before a switch over occurs. Switching partitions is atomic, meaning it occurs or it doesn't—there is no half-way point, no failure post update, etc. Switching partitions allows for the rollup to a new instance of the OS without the need to compromise or influence the original processes, allowing for a more secure device.

The appliance preferably establishes a connection to a cryptocurrency wallet, enabling secure storage, management, and interaction with digital assets within the blockchain ecosystem. This may be accomplished, for example, using a QR code scan through the camera of a mobile device. This on-chain transaction will show the binding of the user Wallet to the appliance Hardware. This allows for control mechanisms from the pre-sales, suggesting that a user submit their public address to be whitelisted.

In an embodiment, the appliance generates and assigns unique QR codes that serve as identifiers or access tokens for specific functions within the blockchain network, such as authorizing transactions, accessing specific smart contracts, or verifying identity. During manufacturing, a QR code may be applied to all appliances, which is then how the operator will bind the appliance to their mobile application for operation. This QR code also contains the required information for triggering the minting process of credentials.

Credentials to be minted may include, for example, Network Access Credentials (NAC). A non-fungible, blockchain bound token can be used to represent the user account and the permissions of the user therein. In the example embodiment, a NAC contains several, minor pieces of personal identifiable information that is collected via third party and the record of those verifications is cryptographically hashed into the NAC as metadata. Utilizing zero-knowledge proofs, this data is secured within the token and not discernible to anyone on the blockchain.

The NAC preferably cannot be moved from the cryptographic wallet it was created in. The NAC can be considered an immutable account that is forever bound to the identity of the user. This approach also prevents the creation of more than one account per identity. Instead, a user, or a NAC, could have numerous wallets created under their NAC. In this example embodiment, the NAC is a foundational identifier for users on the blockchain network.

Another credential minted by the system in the example embodiment is a Terminal Access Credential (TAC). In this example, a non-fungible, blockchain-bound token represents a terminal (device/appliance/hardware) that has been associated with a device permissioned to be used on the network. A TAC contains several device-identifiable parameters, such as Device GPS proximity, UDID, GAID, IMEI, Secure ID, etc. These elements are captured and encoded. In this example, the TAC cannot be moved from the wallet it was created in. The TAC is thus an immutable representation of a device that a human has confirmed they want to use their NAC on, or with. In this example, the TAC is a foundational identifier for users on the blockchain network.

Preferably, the NAC and TAC are bonded together in the appliance. The bond between Network Access Credential (NAC) and Terminal Access Credential (TAC) non-fungible tokens ensures that only devices with valid NAC:TAC credential bonds are granted network access, enhancing security and preventing unauthorized access. While a Zero Trust element is already established, an additional level of protection is instantiated by the use of blockchain protocol bound tokens that represent the identity of the user and the identity of the terminal.

Each appliance is preferably preconfigured with a TAC which is assigned during manufacturing and minted on bond with a user's cryptographic wallet, which also is the trigger for the minting of the NAC. Together, the NAC:TAC bond creates an immutable pairing between the user account (wallet address) and the appliance, allowing only that account and that appliance to access and operate the network together, meaning if a different account attempted to access or manipulate the appliance, access would be denied and vice versa.

The appliance also incorporates automation techniques to streamline various processes, such as peer discovery, network configuration, and connection establishment, minimizing manual intervention and improving efficiency.

In an embodiment, the appliance exposes RPC endpoints, allowing remote access and communication with other network peers, facilitating seamless interaction and data exchange. By automatically exposing RPC endpoints, the blockchain network can efficiently scale as new nodes join the network. New nodes can easily locate and connect to existing nodes, facilitating peer-to-peer communication and interaction.

RPC is a communication protocol that allows a program or component to request services or invoke procedures from another program or component over a network. Automated pre-exposure simplifies the integration of new nodes or clients into the blockchain network. Nodes can discover and connect to available RPC endpoints without requiring manual configuration or explicit knowledge of each node's network details. In a blockchain network, RPC enables nodes or clients to communicate with each other and interact with the blockchain's functionality and data.

RPCs in a blockchain network typically expose a set of predefined functions or methods that can be invoked by clients or other nodes. These functions can include tasks such as submitting transactions, querying the state of the blockchain, retrieving specific data, or executing smart contracts. As the blockchain network evolves, nodes may introduce new RPC functions or update existing ones. Automated pre-exposure enables seamless updates by automatically exposing the updated RPC endpoints, ensuring compatibility and smooth transition for clients and other nodes. Conventional methods of configuration and RPC exposure are complex and require technical expertise. Manual configuration of RPC endpoints for each node can be time-consuming and error prone. Automated pre-exposure, as provided in the example embodiment, eliminates this burden by automatically exposing the necessary RPC endpoints, reducing the chances of misconfiguration.

The automation and pre-configuration elements that have gone into the appliance design allow everyday persons to engage in validation which drastically increases the scalability of the network. Automated pre-exposure facilitates interoperability among different blockchain implementations or protocols. Nodes from different networks can automatically discover and interact with each other's RPC endpoints, enabling cross-network communication and collaboration. Automated pre-exposure helps enhance network resilience by allowing nodes to automatically adapt to changes in the network's topology. If nodes are added or removed, other nodes can dynamically discover and establish connections to maintain network availability.

In an example embodiment, the blockchain network actively seeks new devices that meet predefined qualifications and requirements, ensuring that only trusted and compatible devices are included in the network. In examples using a WARP client, the preconfigured client knows which RPC endpoints and private network peers to look for, making the discovery and connection therein as simple as connecting to the network.

In an embodiment, mechanisms are preferably provided for firmware, software and network updates. The appliance preferably automatically checks for updates from a primary repository for drivers, firmware, software and any other updates the appliance will need on a regular basis. Updates after the node is live will be done automatically, on an as-needed basis that may or may not require hardware restarts. In the event a non-critical update is required, operators will be notified via the mobile application for managing their hardware that will require manual interaction to trigger the updates and the restart. When the node updates and restarts, it will automatically reconnect to the network. This service interruption may impact staking contract rules laid out by the operator which will lead them to require specific timing as to when to trigger the update. In the event a critical update is required, operators will be notified but the manual input from the operator. Instead, the update will force a reboot and reconnect to the network. Critical updates are ones that cannot wait. A special flag may be introduced to prevent the reputation or staking reward loss due to unscheduled, critical updates. Most updates will be done in a “rolling” nature, that only influences a specific, low percentage, quantity of the nodes on the network at a given time, ensuring that the network is both maintained yet updating.

When connected to the network, after any required updates are done, the appliance will begin its synchronization with the blockchain record and then engage with consensus after it is caught up with the blockchain state and records. Each appliance will be required to maintain a Full Node status as referenced by the Substrate Framework, which requires the ability to participate in consensus and maintain a record of the blockchain's current state.

The appliance supports the execution of and interaction with smart contracts, enabling automated and trustless execution of predefined conditions and agreements within the blockchain network. In an embodiment, each appliance will be discoverable and intractable within certain constraints by smart contracts within the blockchain network. Operators are able to deploy a smart contract from their appliance which is representative of a staking pool associated with the specific hardware device. The smart contract has predefined obligations, ranging from pay rates, requirements, terms and conditions, termination clauses, lock periods, durations, etc. All of these parameters must be defined by the operator either through the use of a template or custom entries.

Preferably, the appliance actively participates in the blockchain network's consensus mechanism, contributing to the agreement and validation of transactions and ensuring the integrity of the distributed ledger. This system directly involves the appliance itself due to its unique hardware signature.

In the example embodiment, as a node in the blockchain network, the appliance verifies and validates transactions and blocks, maintaining the accuracy and consistency of the blockchain ledger. Defined within the Substrate framework, all appliances are considered to be Full Nodes. Each appliance is equipped (in an example embodiment) with a CPU, RAM and onboard NVMe SSD in the M.2 form factor. Generation 1 appliances may be based on Generation 13 Intel NUC with: Intel i5-1350P, 32 GB Kingston RAM, and 2 TB Western Digital NVMe SSD (M.2) Storage. In this example, appliances do not employ a dedicated GPU but have embedded graphics. Generation 2 appliances may employ a similar schema.

Security is an important element of preferred example embodiments. In these embodiments, the appliance prioritizes security measures, incorporating robust encryption algorithms, authentication protocols, and secure data transmission techniques to protect sensitive information and prevent unauthorized access.

By functioning as a node in a P2P blockchain network, the appliance contributes to the decentralization of the overall system, ensuring that no single entity has control over the network and promoting a distributed consensus model.

In an example embodiment, a network-based digital resource, referred to herein as the “Energy Resource” is provided in lieu of the traditional blockchain mechanism known as “gas.” The Energy Resource system, in theory, can transcend this embodiment to include multiple or internal network resources. The Energy Resource preferably works in conjunction with a cryptographic token. When this token is committed to the consensus algorithm, such as a Proof of Valued Participation algorithm, this stake works with an additional algorithm to generate the Energy Resource which is used for network operations.

The system is not limited to the use of the Energy Resource and a Proof of Stake. Proof of Valued Participation is a hybrid consensus model that includes elements from both Proof of Stake and Proof of Authority, with the Energy Resource and a Reputation system also involved.

The Energy Resource becomes a commodity within the internal economy of the blockchain network in which it is deployed. This commodity is preferably used for all blockchain-based transactions. The Energy Resource is preferably used in conjunction with a staking algorithm as a control method within the network. Traditionally, on networks such as Ethereum or Bitcoin, the native cryptocurrency (ETH or BTC respectively) is used to reward the validators or miners for their efforts in securing the network. The platform disclosed herein, with its novel consensus method, rewards its participants through the Energy Resource instead of the native currency. However, the internal economy, which is directly created by this system, includes the ability to extend the Energy Resource, as a supply:demand ratio basis, to a native token from a specified portion of the total supply of the Energy Resource, referred to herein as the Staking Reward Allocation.

In the example embodiment, Staking Reward Allocation is dynamic, but predetermined to be a set quantity of the fixed supply upon launch of the network. Staking Reward Allocation consists of the native token which acts as liquidity for users that wish to sell their Energy Resource to the platform. Users, or generators in this context, will seek to sell their Energy Resource to the network to claim these rewards to be formally compensated for their network support.

The Energy Resource, as a system, is intended in example embodiments to streamline the blockchain economy while supporting the reward system required to maintain a secure P2P network. As a P2P network, blockchains often incentivize users to participate in the validation of the ledger transactions by rewarding those users based on the amount of transactions they participate in. With the example blockchain network and Proof of Valued Participation, this model is modified to provide an off-shoot reward for maintaining a connection of an appliance hardware device to the network. When this connection is maintained, the rewards are provided. The network is benefited by having an appliance connected to it due to how the appliances, as described elsewhere herein, are designed to automatically connect to the blockchain network and seamlessly participate in its duties. Therefore, the owner of the appliance only needs to connect the hardware device to both power, internet and their network wallet address to confirm they are supporting the network. With the major deviation from the standards presented by blockchain networks, new and old, the example blockchain network is able to reward users not by transactions, but by participation provisioning hardware resources in the form of appliances.

Energy Resources are preferably generated on a per-second basis at a rate dictated by the network demand on a per-second basis. If there is a large quantity of Energy Resource being used, and as such, consumed (destroyed or burned in a more traditional blockchain sense), the amount of Energy Resource that needs to be generated will be increased, spread across all of the staked native tokens (the tokens committed to the consensus algorithm).

Network Demand may be calculated on a second-by-second basis, dynamically. Network Generation may be set equal to Demand*1.05, ensuring a slight surplus is always being generated. Energy Resource rewards may be tracked, for example, as a form of data within an NFT that is unique to each user. This Energy Resource can be considered metadata, which can be traded for cryptocurrency through the automated system as will be further explained.

In an example embodiment, Energy Resource rewards are paid every 4 epochs, where 1 epoch equates to approximately 6 hours and therefore distributed every 24 hours. Energy Resources are generated by staked native tokens, which isolates the network's source of the Energy Resource to those that are supporting the network through the commitment (stake) of the native token to the consensus algorithm.

In an embodiment, Energy Resource trading is considered as part of the baseline system through a feature referred to herein as the Energy Broker. This Energy Broker is a system that manages the price ratios between the native token and Energy Resource, accounting for both supply and demand within the blockchain network. While similar in concept to decentralized liquidity and market making, the Energy Broker preferably functions more like a decentralized auction house system that will accept bids and facilitate sales. The Energy Broker, when sold to, will return native tokens equal to 80% of the current market rate, allowing for the network to ensure liquidity in both Energy Resources and native tokens for a sustainable future.

In addition to a stake-based control system through consensus, appliances, as hardware, along with their human-side operator/owner, generate a numerical Reputation score in certain example embodiments. In this example, the Reputation score is based on an algorithm that is positively impacted by non-malicious validation/action on the blockchain and negatively impacted by malicious actions. Reputation is algorithmically generated per transaction. Reputation is broken down into tiers which, when achieved, grant new permissions for the operator to have their hardware participate in activities at different levels of the blockchain. Some of the blockchain sub networks may require a higher level of Reputation Tiers. Operators preferably earn Energy Resource rewards varying with their Reputation tier.

In optional embodiments, specific hardware may be recruited for position-limited acceptance of appliances that have the required Reputation. Reputation Tier relegation is then dynamically enforced. If a user requires a score of 100,000 to maintain a specific tier and said operator drops below that after participating in malicious behavior, they will be relegated to a lower reputation tier and enter a probationary status. Operators can have their credentials (NAC & TAC based) blacklisted from the network in response to a low Reputation score.

Hardware appliances have unique opportunities to be used outside of blockchain validation when composed with different varieties in alternative embodiments of the invention. In this example, three complete personas are provided. Additional personas can be provided to meet specific needs, within the intended scope of the invention.

A first persona is the Appliance-Validate persona.

A second persona is the Appliance-Regulatory Compliance persona. Such appliances are adapted for decentralized, privacy-enabled and secure artificial intelligence inference and training to monitor regulatory compliance. As an example, Hardware specifications for this person may include CPU: 24 Core, 48 Thread (Intel i9), RAM: 256 GB DDR5 (Kingston), GPUs: RTX Titan x2 (Nvidia), and Storage: 100 TB (Western Digital Black). While these specifications and products used are considered for the first implementation, other configurations may be implemented within the intended scope of the invention.

A third persona is the Appliance-Storage persona designed for secure decentralized cloud storage. As one example, hardware specifications for this persona may include: CPU: 12 Core, 12 Thread (Intel i5), RAM: 16 GB DDR4 (Kingston), GPU: N/A, Storage: 200 TB (Western Digital Black). While these specifications and products used are considered for the first implementation, other configurations may be implemented within the intended scope of the invention.

All appliances preferably cooperate through the aforementioned tunneling protocol and blockchain network. They can preferably speak to each other natively for a coherent interconnect based on the blockchain network alone. Each appliance persona creates a self-connecting P2P network that can be communicated with by the other personas. Each appliance persona can conscript other appliances to support their computational or storage needs for a specific job or command to ensure the needs of the end user are met. Each appliance is only temporarily granted permissions to certain functions beyond their initial scope from blockchain platform users. Example, as seen on the example blockchain platform include:
Business users who will send data to an AI model for inference and then to decentralized storage.
Users who initiate a blockchain transaction that triggers data to be validated by Appliance-Validate personas.

After validation that data has been sent, the data is processed on the blockchain subnet that handles AI workloads. An Appliance-Validate persona will communicate the job and its requirements to the subnet and the required models and processes are spooled into 1 or more Appliance-Compliance personas as dictated by an orchestration module. The job is run by Appliance-Compliance and then validated by the blockchain network through Appliance-Validate.

After the AI job is completed and confirmed, the Appliance-Compliance personas are stripped of their permissions to the data originally sent across the blockchain. This data is sent to the blockchain subnet that handles decentralized storage. This is handled by Appliance-Validate.

Once validated on the data storage subnet by Appliance-Validate, the storage orchestration is provided the data to begin its dissemination through Appliance-Storage as needed utilizing decentralized data storage norms such as Reed-Soloman Erasure Coding, Distributed Hash Tables, etc. This data storage is once again validated by Appliance-Validate.

Although illustrative embodiments have been described herein in detail, it should be noted and understood that the descriptions and drawings have been provided for purposes of illustration only and that other variations both in form and detail can be added thereto without departing from the spirit and scope of the invention. The terms and expressions in this disclosure have been used as terms of description and not terms of limitation. Thus, the breadth and scope of the present invention should not be limited by any of the above-described exemplary embodiments but should be defined only in accordance with the claims and their equivalents. The terms and expressions herein should not be interpreted to exclude any equivalents of features shown and described, or portions thereof.

We claim:

1. A method for automated connection of computing appliance as nodes in a blockchain network that implements predetermined consensus and validation processes, comprising the steps of:
Providing a plurality of computing appliances, each having a processor that operates a zero-trust client to create a standardized secure peer-to-peer network connection between the computing appliances to establish each appliance as a node in the blockchain network;
Executing preconfigured connection instructions that automatically connect the appliances to the blockchain network using said client;
Electronically connecting at least one appliance to a Cryptographic Wallet;
Initiating operation of node software in the appliances enabling the appliances to participate in the blockchain network as nodes to contribute to said consensus and validation; and
Automatically performing network-bound listening events within the appliances to identify and connect to peer nodes to perpetuate the peer-to-peer blockchain network.

2. The process of claim 1 wherein an appliance performs at least one of: consensus validation functions for the blockchain, AI interface and training workloads for network users, and providing decentralized data storage space.
